(19) United States
(12) Patent Application Publication
(10) Pub. No.: US 2014/0122069 A1
(43) Pub. Date: May 1, 2014

(54) Automatic Speech Recognition Accuracy Improvement Through Utilization of Context Analysis

(71) Applicant: INTERNATIONAL BUSINESS MACHINES CORPORATION, Armonk, NY (US)

(72) Inventors: Seth E. Bravin, Frederick, MD (US); Brian J. Cragun, Rochester, MN (US); Robert A. Foyle, Orange, CA (US); Ali Sobhi, Austin, TX (US)

(73) Assignee: International Business Machines Corporation, Armonk, NY (US)

(21) Appl. No.: 13/663,546

(22) Filed: Oct. 30, 2012

(51) Int. Cl. G10L 15/26

(52) U.S. Cl. 704/235; 704/E15.043

(57) ABSTRACT

A mechanism is provided for utilizing content analytics to automate corrections and improve speech recognition accuracy. A set of current corrected content elements is identified within a transcribed corrected media. Each current corrected content element in the set of current corrected content elements is weighted with an assigned weight based on one or more predetermined weighting conditions and a context of the transcribed corrected media. A confidence level is associated with each corrected content element based on the assigned weight. The set of current corrected content elements and the confidence level associated with each current corrected content element in a set of corrected elements is stored in a storage device for use in a subsequent transcription correction.

### BACKGROUND

The present application relates generally to an improved data processing apparatus and method and more specifically to mechanisms for improving automatic speech recognition accuracy through utilization of context analysis.

Speech recognition (SR) is the translation of spoken words into text. Speech recognition, also known as automatic speech recognition (ASR), “training”, where an individual speaker reads sections of text into the SR system, the SR system analyzes the person's specific voice and fine tunes the recognition of that person's speech, resulting in more accurate transcription. The utilization of voice recognition may simplify the task of translating speech in systems that have been trained on specific person's voices or may be used to authenticate or verify the identity of a speaker as part of a security process.

However, voice recognition alone only provides some improvement to the accuracy of the transcription. That is, the accuracy of automatic translation systems are also improved by developers running test cases and tweaking the automatic translation systems rules to produce better results. However, constant tweaking requires numerous man-hours which results in increased cost.

### SUMMARY

In one illustrative embodiment, a method, in a data processing system, is provided for utilizing content analytics to automate corrections and improve speech recognition accuracy. The illustrative embodiment identifies a set of current corrected content elements within a transcribed corrected media. The illustrative embodiment weights each current corrected content element in the set of current corrected content elements with an assigned weight based on one or more predetermined weighting conditions and a context of the transcribed corrected media. The illustrative embodiment associates a confidence level with each corrected content element based on the assigned weight. The illustrative embodiment stores the set of current corrected content elements and the confidence level associated with each current corrected content element in a set of corrected elements in a storage device for use in a subsequent transcription correction.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts an example of a context analysis automatic speech recognition system in accordance with an illustrative embodiment;

FIG. 4 depicts a flowchart of an exemplary operation performed by a context analysis automatic speech recognition (ASR) mechanism in accordance with an illustrative embodiment; and

FIG. 5 depicts an exemplary process performed by the context analysis ASR mechanism in correcting transcribed media in accordance with an illustrative embodiment.

### DETAILED DESCRIPTION

The illustrative embodiments provide mechanisms that intelligently utilize context analysis to automate corrections and automatically improve automatic speech recognition (ASR) accuracy. The mechanisms utilize the context analysis to identify the context of a transcription and analyze relevant content in view of the identified context in order to understand concepts, relationships, and patterns within the content in view of the identified context. The mechanisms apply the results of the context analysis to, for example, a second pass of an ASR process to improve ASR accuracy. By applying the context analysis in such a manner, the mechanisms reduce manual editing work and provide a loop of feedback enhancement to the underlying ASR. This results in a continuous improvement of the ASR and a corresponding decrease in cost of correcting the output. Additionally, any subsequent ASR of another received transcription benefits from the improved accuracy.

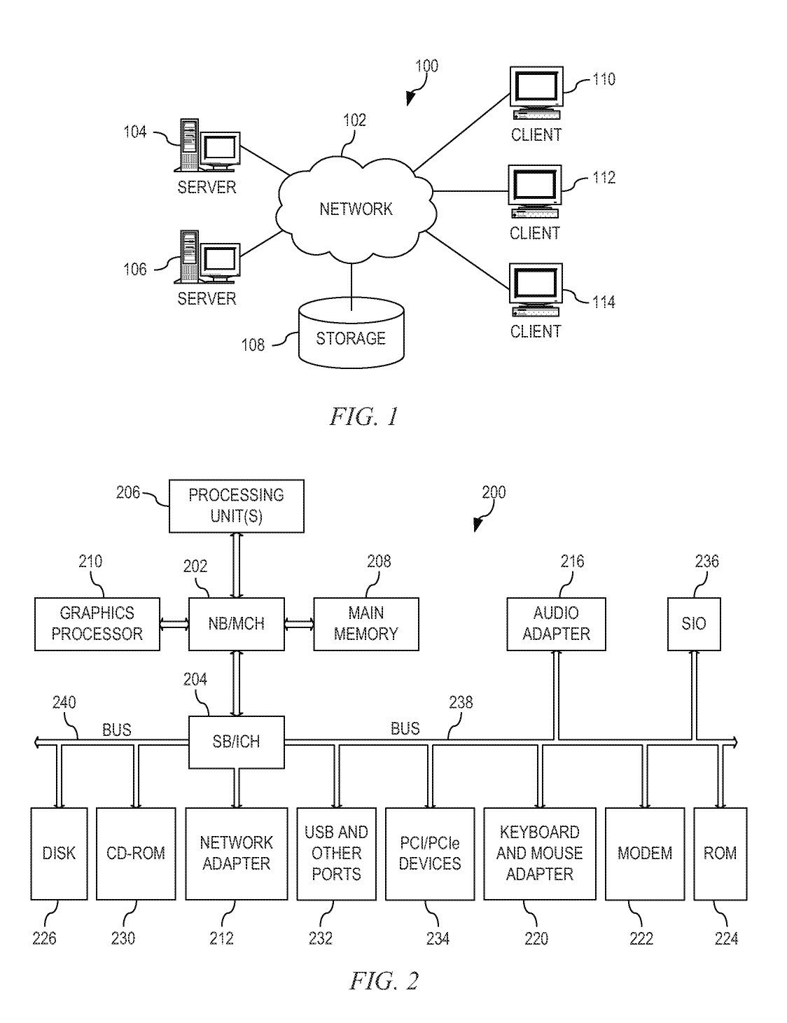

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modern 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive) (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

The illustrative embodiments provide mechanisms that intelligently utilize context analysis to automate corrections and automatically improve automatic speech recognition (ASR) accuracy. The mechanisms analyze a received media transcription to identify a context of the media transcription and correct the media transcription based on the identified context and previous corrections in view of the identified context. The mechanisms then analyze the corrected media transcription to identify a set of corrected content elements. Utilizing the identified context, the corrected content elements are weighted based on the identified context. That is, some corrections may be more statistically prevalent based on the identified context than other corrections made during the correction process. Thus, the mechanisms may indicate through the weighting process that some corrections are more accurate or less accurate. If the weighting process indicates a more accurate correction, then the mechanisms may associate a higher confidence level to the correction. Likewise, if the weighting process indicates a less accurate correction, then the mechanisms may associate a lower confidence level to the correction. The mechanisms store the corrections and associated confidence levels for subsequent media transcription corrections.

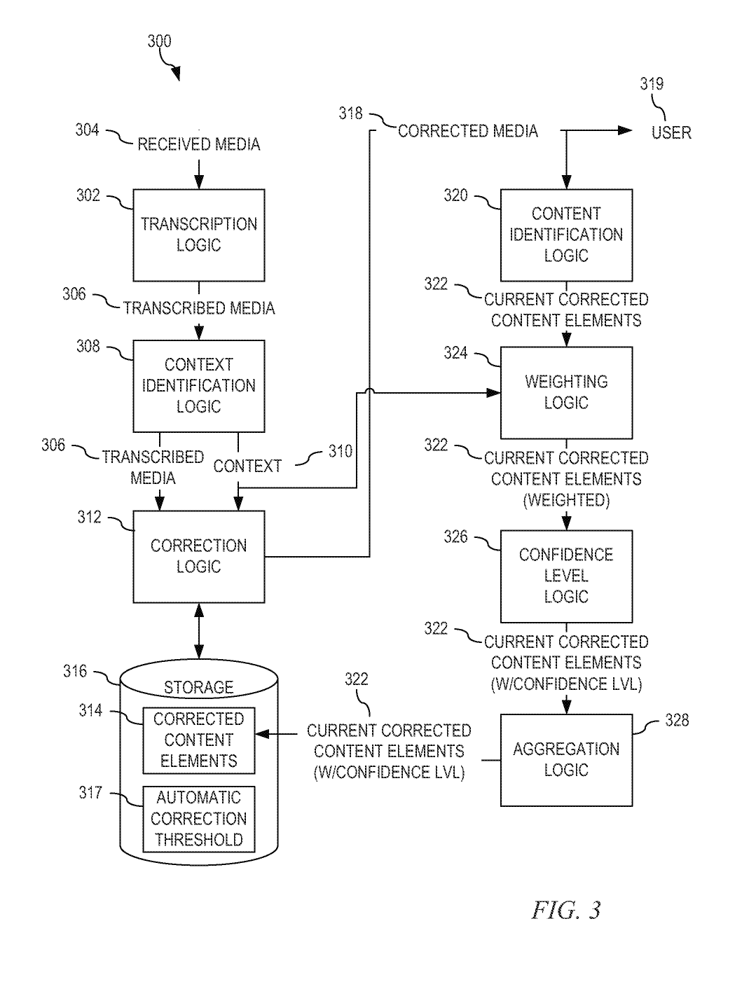

FIG. 3 depicts an example of a context analysis automatic speech recognition system in accordance with an illustrative embodiment. In exemplary context analysis automatic speech recognition system 300, transcription logic 302 receives media 304 and provides transcribed media 306 to context identification logic 308. Context identification logic 308 identifies context 310 of transcribed media 306 utilizing context from transcribed media 306, such as identification of a speaker, topics being discussed, language being used, or the like. Additionally, context identification logic 308 may identify context 310 of transcribed media 306 based on metadata that is embedded in transcribed media 306, which may have been captured and forwarded by transcription logic 302 when transcribing received media 304.

Correction logic 312 then utilizes context 310 to analyze and correct transcribed media 306. Utilizing context 310, correction logic 312 identifies content elements with errors in transcribed media 306 and, for each identified erred content element, may either mark the identified erred content element for administrative review or automatically correct the identified erred content element. Correction logic 312 may automatically correct the identified erred content element based on a comparison of the identified erred content element to a set of corrected content elements 314 stored in storage 316. That is, the set of corrected content elements 314 comprises associations between erred content elements, corrections made to the erred content elements, and a confidence level. correction logic 312 identifies an erred content element in the set of corrected content elements 314 that matches the identified erred content element, then correction logic 312 determines whether the confidence level associated with the erred content element is above predetermined automatic correction threshold 317. If the confidence level is greater than or equal to predetermined automatic correction threshold 317, then correction logic 312 automatically corrects the identified erred content element with the associated correction from the set of corrected content elements 314. If the confidence level is less than predetermined automatic correction threshold 317, then correction logic 312 marks the identified erred content element for administrative review. Once correction logic 312 analyzes all of the content within transcribed media 306 and either marks one or more identified content elements for administrative review and/or automatically corrects one or more of the identified erred content elements, correction logic 312 produces corrected media 318 that includes transcribed media 306 with indications of marked content elements and automatically corrected content elements.

Correction logic 312 may send corrected media 318 to user 319 as well as content identification logic 320. Content identification logic 320 identifies each corrected content element within the corrected media 318 thereby forming a set of current corrected content elements 322, each corrected content element including the erred content element and the correction made to the erred content element. Once content identification logic 320 identifies the set of current corrected content elements 322, content identification logic 320 sends the set of current corrected content elements 322 to weighting logic 324. Weighting logic 324 weights each of the set of current corrected content elements 322 utilizing context 310. That is, weighting logic 324 associates a weight with each corrected content element in the set of current corrected content elements 322 based on a statistical significance of the word or phrase of the corrected content element to the subject matter or context 310 with which the corrected content element is associated.

Once weighting logic 324 weights all of the set of current corrected content elements 322, confidence level logic 326 utilizes the associated weight to associate a confidence level with each corrected content element within the set of current corrected content elements 322. That is, for example, if weighting logic associates a weight of 89 to a corrected content element on a scale of 1-100, then confidence level logic 326 will associate a high confidence level to the corrected content element. Once confidence level logic 326 associates a confidence level with each corrected content element in the set of current corrected content elements 322, aggregation logic 328 aggregates the set of current corrected content elements 322 and their associated confidence levels into the set of corrected content elements 314 for use in subsequent corrections of transcribed media. In order to benefit from the newly aggregated corrected content elements based on the content analysis performed by content identification logic 320, weighting logic 324, and confidence level logic 326, the illustrative embodiment also provide for correction logic 312 to re-analyze corrected media 318 to improve the accuracy of the corrections made to corrected media 318 and reduce the marked identified content elements for administrative review.

Thus, the illustrative embodiments provide advantages over currently known automatic speech recognition (ASR) systems utilizing immediate content analysis to improve the speed and accuracy of the corrections. In this way, with each successive cycle performed by the context analysis automatic speech recognition system, the correction performed by the correction logic is improved and the number of transcription corrections requiring administrator input decreases. Content analytics may be used with content from content management systems or used in conjunction with other unstructured data from any other corporate system or outside sources.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

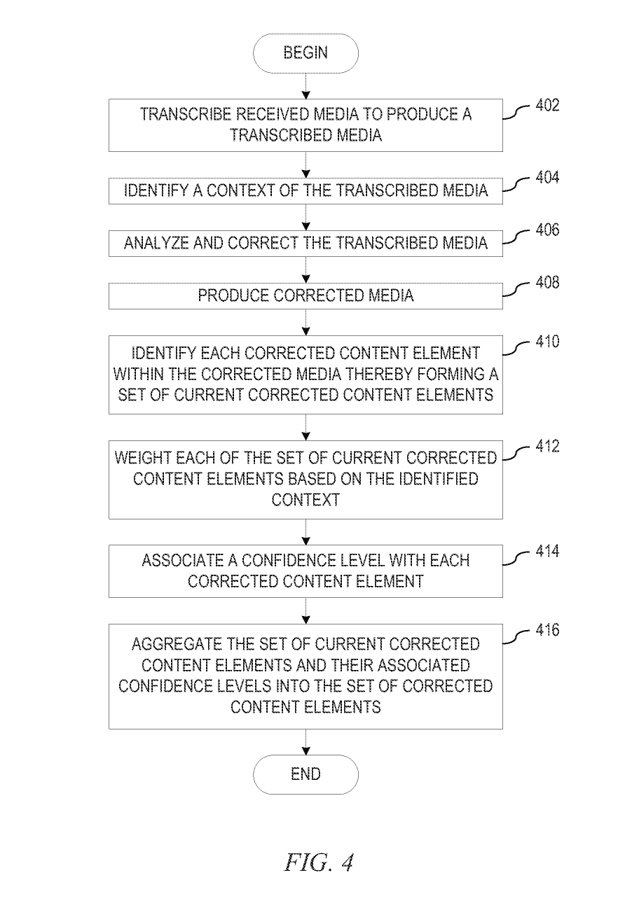

FIG. 4 depicts a flowchart of an exemplary operation performed by a context analysis automatic speech recognition (ASR) mechanism in accordance with an illustrative embodiment. As the operation begins, the context analysis ASR mechanism, such as context analysis ASR system 300 of FIG. 3, executed by a processor, such as processing unit 206 of FIG. 2, transcribes received media in order to produce transcribed media (step 402). The context analysis ASR mechanism identifies a context of the transcribed media (step 404) by performing one or more of identifying a speaker within the transcribed media, identifying a topic of the transcribed media, identifying a language of the transcribed media, and/or analyzing metadata associated with the transcribed media.

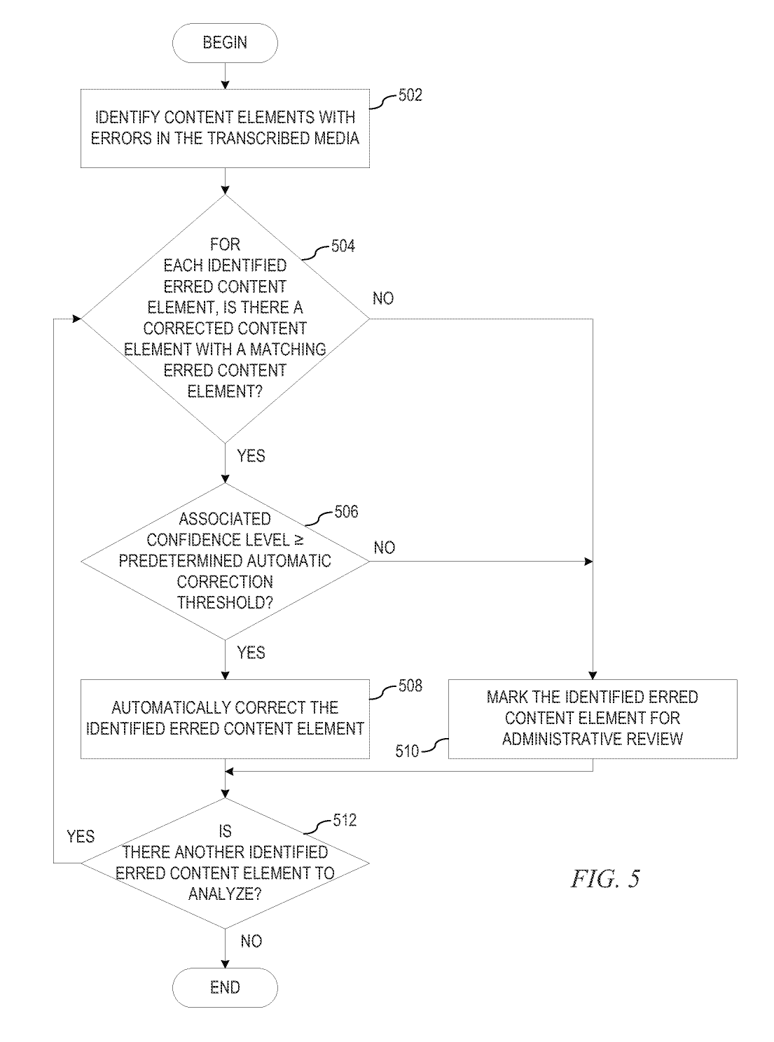

The context analysis ASR mechanism then utilizes the identified context and a set of corrected content elements to analyze and correct the transcribed media (step 406), which is described in detail in FIG. 5. Once the context analysis ASR mechanism has analyzed all of the content within the transcribed media, the context analysis ASR mechanism produces corrected media that includes the transcribed media with indications of marked content elements and automatically corrected content elements (step 408). The context analysis ASR mechanism then identifies each corrected content element within the corrected media thereby forming a set of current corrected content elements (step 410), each corrected content element including an indication of an associated erred content element and the correction made to the erred content element. Once the context analysis ASR mechanism identifies the set of current corrected content elements, the context analysis ASR mechanism weights each of the set of current corrected content elements based on the identified context (step 412). That is, the context analysis ASR mechanism associates a weight with each corrected content element in the set of current corrected content elements based on a statistical significance of the word or phrase of the corrected content element related to the identified context with which the corrected content element is associated.

Once the context analysis ASR mechanism weights all of the set of current corrected content elements, the context analysis ASR mechanism utilizes the associated weight to associate a confidence level with each corrected content element within the set of current corrected content elements (step 414). The context analysis ASR mechanism then aggregates the set of current corrected content elements and their associated confidence levels into the set of corrected content elements for use in subsequent corrections of transcribed media (step 416), with the operation ending thereafter.

FIG. 5 depicts an exemplary process performed by the context analysis ASR mechanism in correcting transcribed media in accordance with an illustrative embodiment. As the operation begins, the context analysis ASR mechanism, executed by a processor, identifies current content elements with errors in the transcribed media (step 502). For each identified erred content element, the context analysis ASR mechanism compares of the identified erred content element to a set of corrected content elements (step 504), each corrected content element in the set of corrected content elements comprising an erred content element, corrections made to the erred content elements, and a confidence level. If at step 504 there is a match between the identified erred content element and an erred content element in a corrected content element in the set of corrected content elements, the context analysis ASR mechanism determines whether the associated confidence level is greater than or equal to a predetermined automatic correction threshold (step 506). If at step 506 the associated confidence level is greater than or equal to the predetermined automatic correction threshold, then context analysis ASR mechanism automatically corrects the identified erred content element with the associated correction from the identified corrected content element (step 508).

If at step 506 the associated confidence level is less than the predetermined automatic correction threshold, the context analysis ASR mechanism marks the identified erred content element for administrative review (step 510). From steps 508 and 510, the context analysis ASR mechanism determines whether there is another identified erred content element to analyze (step 512). if at step 512 there is another identified erred content element to analyze, the operation returns to step 504. If at step 504 there fails to be a match between the identified erred content element and an erred content element in a corrected content element in the set of current corrected content elements, the operation proceeds to step 510. If at step 512 there is not another identified erred content element to analyze, the operation terminates.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms that intelligently utilize context analysis to automate corrections and automatically improve automatic speech recognition (ASR) accuracy. The mechanisms utilize the context analysis to identify the context of a transcription and analyze relevant content in view of the identified context in order to understand concepts, relationships, and patterns within the content in view of the identified context. The mechanisms apply the results of the context analysis to, for example, a second pass of an ASR process to improve ASR accuracy. By applying the context analysis in such a manner, the mechanisms reduce manual editing work and provide a loop of feedback enhancement to the underlying ASR. This results in a continuous improvement of the ASR and a corresponding decrease in cost of correcting the output. Additionally, any subsequent ASR of another received transcription benefits from the improved accuracy.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks, Moderns, cable moderns and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for utilizing content analytics to automate corrections and improve speech recognition accuracy, the method comprising:
identifying, by a processor, a set of current corrected content elements within a transcribed corrected media;
weighting, by the processor, each current corrected content element in the set of current corrected content elements with an assigned weight based on one or more predetermined weighting conditions and a context of the transcribed corrected media;
associating, by the processor, a confidence level with each corrected content element based on the assigned weight; and
storing, by the processor, the set of current corrected content elements and the confidence level associated with each current corrected content element in a set of corrected elements in a storage device for use in a subsequent transcription correction.

2. The method of claim 1, wherein the context of the scribed corrected media identifies at least one of a speaker, a language, or a topic.

3. The method of claim 1, further comprising:
storing, by the processor, an erred content element associated with each current corrected element in the set of corrected elements in the storage device.

4. The method of claim 1, further comprising:
aggregating, by the processor, an additional set of current corrected elements and their associated confidence levels associated with other received transcriptions in the set of corrected elements in the storage device.

5. The method of claim 1, wherein the subsequent transcription correction corrects a received transcribed media by the method comprising:
identifying, by the processor, content elements within the received transcribed media thereby forming a set of erred content elements;
for each erred content element in the set of content elements, determining, by the processor, whether there is a erred content element associated with a corrected content element in the set of corrected elements in the storage device that matches the erred content element;
responsive to the match, determining, by the processor, whether a confidence level associated with the corrected content element in the set of corrected elements in the storage device is greater than a predetermined automatic correction threshold; and
responsive to the confidence level being greater than or equal to the predetermined automatic correction threshold, automatically correcting, by the processor, the erred content element with the corrected content element.

6. The method of claim 5, further comprising:
responsive to failure to match the erred content element in the set of content elements with the erred content element associated with any corrected content element in the set of corrected elements in the storage device, marking, by the processor, the erred content element in the set of content elements for administrative review.

7. The method of claim 5, further comprising:
responsive to the confidence level being less the predetermined automatic correction threshold, marking, by the processor, the erred content element in the set of content elements for administrative review.

8. The method of claim 1, wherein the subsequent transcription correction is at least one of a re-correction of the transcribed corrected media or a correction of a newly received transcribed media.

9. A computer program product comprising a computer readable storage medium having a computer readable program stored therein, wherein the computer readable program, when executed on a computing device, causes the computing device to:
identify set of current corrected content elements within a transcribed corrected media;
weight each current corrected content element in the set of current corrected content elements with an assigned weight based on one or more predetermined weighting conditions and a context of the transcribed corrected media;
associate a confidence level with each corrected content element based on the assigned weight; and
store the set of current corrected content elements and the confidence level associated with each current corrected content element in a set of corrected elements in a storage device for use in a subsequent transcription correction.

10. The computer program product of claim 9, wherein the context of the transcribed corrected media identifies at least one of a speaker, a language, or a topic.

11. The computer program product of claim 9, wherein the computer readable program further causes the computing device to:
store an erred content element associated with each current corrected element in the set of corrected elements in the storage device.

12. The computer program product of claim 9, wherein the computer readable program further causes the computing device to:
aggregate an additional set of current corrected elements and their associated confidence levels associated with other received transcriptions in the set of corrected elements in the storage device.

13. The computer program product of claim 9, wherein the subsequent transcription correction corrects a received transcribed media by the computer readable program further causing the computing device to:
identify content elements within the received transcribed media thereby forming a set of erred content elements;
for each erred content element in the set of content elements, determine whether there is a erred content element associated with a corrected content element in the set of corrected elements in the storage device that matches the erred content element;
responsive to the match, determine whether a confidence level associated with the corrected content element in the set of corrected elements in the storage device is greater than a predetermined automatic correction threshold; and
responsive to the confidence level being greater than or equal to the predetermined automatic correction threshold, automatically correct the erred content element with the corrected content element.

14. The computer program product of claim 13, wherein the computer readable program further causes the computing device to:
responsive to failure to match the erred content element in the set of content elements with the erred content element associated with any corrected content element in the set of corrected elements in the storage device, mark the erred content element in the set of content elements for administrative review.

15. The computer program product of claim 13, wherein the computer readable program further causes the computing device to:
responsive to the confidence level being less the predetermined automatic correction threshold, mark the erred content element in the set of content elements for administrative review.

16. The computer program product of claim 9, wherein the subsequent transcription correction is at least one of a re-correction of the transcribed corrected media or a correction of a newly received transcribed media.

17. An apparatus, comprising:
a processor; and
a memory coupled to the processor, wherein the memory comprises instructions which, when executed by the processor, cause the processor to:
identify set of current corrected content elements within a transcribed corrected media;
weight each current corrected content element in the set of current corrected content elements with an assigned weight based on one or more predetermined weighting conditions and a context of the transcribed corrected media;
associate a confidence level with each corrected content element based on the assigned weight; and
store the set of current corrected content elements and the confidence level associated with each current corrected content element in a set of corrected elements in a storage device for use in a subsequent transcription correction.

18. The apparatus of claim 17, wherein the context of the transcribed corrected media identifies at least one of a speaker, a language, or a topic.

19. The apparatus of claim 17, wherein the instructions further cause the processor to:
store an erred content element associated with each current corrected element in the set of corrected elements in the storage device.

20. The apparatus of claim 17, wherein the instructions further cause the processor to:
aggregate an additional set of current corrected elements and their associated confidence levels associated with other received transcriptions in the set of corrected elements in the storage device.

21. The apparatus of claim 17, wherein the subsequent transcription correction corrects a received transcribed media by the instructions further causing the processor to:
identify content elements within the received transcribed media thereby forming a set of erred content elements;
for each erred content element in the set of content elements, determine whether there is a erred content element associated with a corrected content element in the set of corrected elements in the storage device that matches the erred content element;
responsive to the match, determine whether a confidence level associated with the corrected content element in the set of corrected elements in the storage device is greater than a predetermined automatic correction threshold; and
responsive to the confidence level being greater than or equal to the predetermined automatic correction threshold, automatically correct the erred content element with the corrected content element.

22. The apparatus of claim 21, wherein the instructions further cause the processor to:
responsive to failure to match the erred content element in the set of content elements with the erred content element associated with any corrected content element in the set of corrected elements in the storage device, mark the erred content element in the set of content elements for administrative review.

23. The apparatus of claim 21, wherein the instructions further cause the processor to:
responsive to the confidence level being less the predetermined automatic correction threshold, mark the erred content element in the set of content elements for administrative review.

24. The apparatus of claim 17, wherein the subsequent transcription correction is at least one of a re-correction of the transcribed corrected media or a correction of a newly received transcribed media.
